(19) United States
(12) Patent Application Publication
(10) Pub. No.: US 2025/0208155 A1
(43) Pub. Date: Jun. 26, 2025

(54) DIRECT MATERIAL TRANSFER BETWEEN MODULAR ROBOTIC SYSTEMS

(71) Applicant: Trilobio, Inc., San Francisco, CA (US)

(72) Inventors: Maximilian Eugene SCHOMMER, Huntington Beach, CA (US); Roya AMINI-NAIENI, Huntington Beach, CA (US); Keoni Kealoha GANDALL, Huntington Beach, CA (US)

(73) Assignee: Trilobio, Inc., San Francisco, CA (US)

(21) Appl. No.: 18/842,734

(22) PCT Filed: Mar. 9, 2023
(86) PCT No.: PCT/US2023/064069

§ 371 Date: Aug. 29, 2024

Related U.S. Application Data
(60) Provisional application No. 63/269,056, filed on Mar. 9, 2022.

(51) Int. Cl. G01N 35/00; B25J 9/00

(52) U.S. Cl. CPC G01N 35/0099; B25J 9/0084

(57) ABSTRACT

Disclosed herein are system, apparatus, method and/or computer program product embodiments, and/or combinations and sub-combinations thereof, for a modular laboratory assembly. The modular laboratory assembly may include a central controller and a plurality of biological processing modules. Each biological processing module may include a robotic manipulator, a plurality of transfer decks within a volume of the biological processing module, a plurality of coupling mechanisms on respective sides of the biological processing module, and a module controller in communication with the central controller, the robotic manipulator, and the plurality of coupling mechanisms.

### CROSS-REFERENCE TO RELATED APPLICATIONS

This application claims the benefit of U.S. Provisional Appl. No. 63/269,056, filed Mar. 9, 2022, the disclosure of which is incorporated by reference herein in its entirety.

### TECHNICAL FIELD

Embodiments of this disclosure are generally directed to transferring modules containing materials between modular robotic systems.

### BACKGROUND

Biological laboratory processing requires many distinct processes to be performed on a variety of samples. These processes include transferring liquids from one place to another, placing samples in a centrifuge to separate components, changing the temperature precisely to catalyze specific reactions, and many others. Because of the vast quantity of processes required for biology, and the fact that each lab often requires a unique subset of those processes, fully automating biological processing has proven difficult. Often multiple automated systems are not connected and the transferring is time consuming and difficult.

Most lab automation attempts consist of two basic parts. First may be a set of stations with tools configured to execute specific aspects of biological processes, such as pipettors or centrifuges. Second is a customized external transfer system which may transfer materials from one station to the next, typically programmed to replicate the actions a human would take to transition test elements from one station to the next. The external transfer system may be a conveyor belt, magnetic track, or robotic system designed to execute a dedicated task. Conveyor belts and magnetic tracks running between static stations are typically limited to assembly-line style processes, where biological samples are moved from one station to another via the belt or track. But such systems are often limited to one-way only systems that transfer from station to station “down the line;” any attempts for two-way movement are inefficient because, to avoid crashes between objects moving in two different directions, only a single object may be moved at a time. Custom articulators, on the other hand, such as robots that take the place of humans transporting objects between various stations, are expensive, time-consuming to reprogram, and lock a laboratory unit into a specific configuration.

### BRIEF DESCRIPTION OF THE FIGURES

The accompanying drawings are incorporated herein and form a part of the specification.

FIGS. 1A-1C depict a modular laboratory assembly, according to some embodiments.

FIG. 1D depicts a coupling mechanism for modules in a modular laboratory assembly, according to some embodiments.

FIGS. 2A-2B depict a modular laboratory assembly, according to some embodiments.

FIGS. 3A-3B depict a stacked modular laboratory assembly, according to some embodiments.

FIGS. 4A-4G illustrate movement of an object across a modular laboratory assembly, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for plug-and-play laboratory assembly creation and automatedly transferring materials between modular robotic systems.

A biological processing environment may include a variety of stations containing tools and equipment for use in a given process, such as a freezer or pipettor. Typically, if a human is not responsible for transporting materials between these stations, biology labs may use assembly lines or rail systems that are external to the stations. However, these external systems add additional cost, hardware, and space constraints to the laboratory environment. Additionally, such external systems are inefficient, because linear assembly lines or rail systems can typically only process movement in a single direction at a time.

Embodiments described herein enable a modular laboratory assembly with a self-contained transport system. This allows components to be moved back and forth frequently and with multiple components, unlike linear assembly lines or rail systems that can typically only process movement in a single direction at a time. Such embodiments include mix-and-match modules that transfer materials directly to each other without the need for an external modulator, rails, or a conveyor belt. Rather, execution instructions for a particular operation are issued to on-board manipulators on-the-fly from a central unit. This means that two modules only need to be placed next to each other in order for them to be able to transfer materials between each other. Each module may have its own articulated mechanism thereon that is responsible for moving objects from one location to another, yet which is controlled by a central controller with which it is registered. This system allows for any module to transfer materials to and from adjacent modules, which allows for materials to be transferred anywhere throughout the connected system. Full modularity may be achieved, as described herein. As will be described below, each module is registered to and communicates with a central controller that guides each module to perform specific processing steps in order to execute a given biological process.

For example, when a DNA sample is to be sequenced, previously a user would be required to obtain a sample from a freezer, add the sample to a pipetting machine, and then set up samples within the lab. By using the system described herein, a user may program the system and the array of robotic manipulators throughout the system modules will take the sample from the freezer and transfer the sample to the necessary locations for processing. By using a robotic arm instead of a user, there are less errors and the process is more efficient.

This system requires no special skills to set up and allows for full biology laboratory automation, and a user may configure the system by simply placing modules next to each other. The system requires no track, conveyor, or other transfer system to be configured or set up, which may greatly speed up the integration process. Existing technology requires a custom solution to achieve full automation. The embodiments described herein, specifically using the module ability allows for a fully automated lab without unnecessary customization.

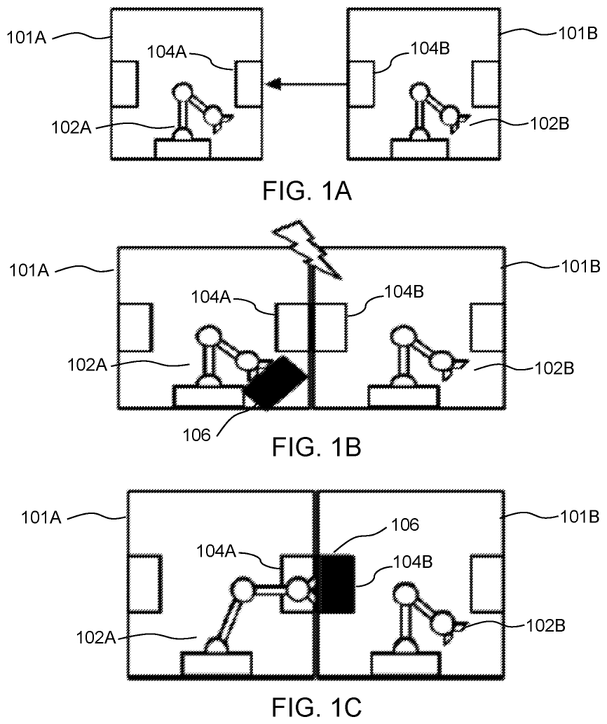

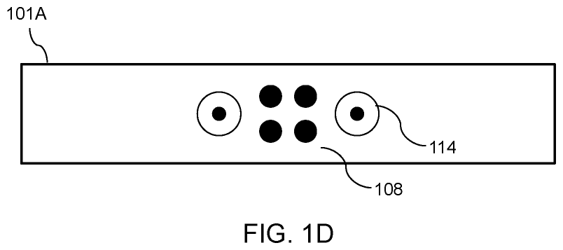

FIGS. 1A-1C depict a side view of an example modular laboratory assembly and use, according to some embodiments.

FIG. 1A illustrates two biological processing modules 101A and 101B. Each biological processing module may perform a particular function, such as pipetting, cooling (e.g., refrigerator or freezer), centrifuging, optical inspection, and the like. Each biological processing module may contain tools and devices needed to accomplish its function. Biological processing module 101A includes a robotic manipulator 102A and multiple transfer decks (or slots) 104A. Similarly, biological processing module 101B includes a robotic manipulator 102B and multiple transfer decks 104B. Each of robotic manipulators 102A and 102B may be a robotic arm with an engagement mechanism that allows the robotic arm to interact with objects within the volume of or near its respective processing module 101. Each robotic manipulator 102 may be an articulable manipulator capable of movement in all directions, and may be positioned anywhere on module 101. The engagement mechanism may be a gripper, a magnetic mechanism, a suction mechanism, a lifter, or the like, for interaction with objects such as plates, tubes, bowls, arrays, and the like. Each biological processing module may have a cuboid shape (e.g., cube, rectangular prism, trapezoidal prism, and the like) having a volume, such as an equipment platform with an overhead and/or side support structure. Alternatively, a biological processing module may include an equipment platform without the overhead structure.

During assembly of the modular system, biological processing modules 101A and 101B are coupled together as shown in FIG. 1B. To allow communication and cooperation between each module in a modular laboratory assembly, a standard input/output (I/O) system may be used. By using a standard I/O system, it is ensured that every device within the system supports the modularity. Specifically, the different modules within the system, such as a freezer module and an automatic pipetting module, must be able to communicate between each other. A biological processing module may include, for example and without limitation, a freezer, a refrigerator, a pipettor, an incubator, an optical analysis device, a heater, a centrifuge, a PCR machine, a sequencer, a room temperature storage module, a shaker, a gripper, a tube and tube cap manipulator, a spectrophotometer, and/or various metrology devices. A skilled artisan will recognize that a biological processing module may also include a custom hardware component programmed to use the standard I/O system.

FIG. 1D illustrates a side view of a base of a biological processing module, such as module 101A. In some embodiments, each side of each processing module may contain a coupling mechanism 108. While FIG. 1D illustrates the coupling mechanism on a base of the module, a skilled artisan will recognize that the coupling mechanism can alternatively be placed on any common surface (such as a side support column or an overhead support structure) accessible to adjoining modules. Coupling mechanism 108 may be a standard electrical connector allowing bidirectional communication between both devices. In the example of FIG. 1D, coupling mechanism 108 is shown as a combination of pogo pins and mating pads. Coupling mechanism 108 may have both data and ground connections. When coupled to another processing module, such as module 101B having its own coupling mechanism 108, pogo pins of module 101A are received on mating pads of module 101B, while pogo pins of module 101B are received on mating pads of module 101A. While FIG. 1D illustrates a pogo pin and pad arrangement, a skilled artisan would recognize that other pogo pin arrangements, or other coupling mechanisms besides pogo pins, may be used to electrically connect two modules. In order to mix and match the layout of the modules, a physical layout of each coupling mechanism may be the same to allow any one module to be coupled to another model.

Each processing module may also include one or more alignment guides 114 used to align the processing modules with each other. This may be important so that the robotic manipulators present on each module 101 can accurately transfer materials to adjacent modules. Each biological processing module may have such coupling mechanisms on each side of the module to which another biological processing module may be located. In order to mix and match the layout of the modules, a physical layout of each alignment mechanism may be the same to allow any one module to be coupled to another model.

Once biological processing module 101A is coupled to biological processing module 101B, as shown in FIG. 1B, robotic manipulator 102A can operate to move an object, such as object 106, to a location on or within biological processing module 101B. Robotic manipulator 102A may retrieve object 106 from a location on its own module (i.e., module 101A), or robotic manipulator 102A may retrieve object 106 from a location on a neighboring module (not shown).

As illustrated in FIG. 1C, robotic manipulator 102A may place, insert, or otherwise deliver object 106 to transfer deck (or slot) 104B on module 101B. Robotic manipulator 102B can then access object 106 to move it to another location on module 101B for processing, or to further transfer object 106 to a neighboring module.

While FIGS. 1B and 1C depict robotic manipulator 102A transferring object 106 to processing module 101B, such movement capabilities may be bidirectional such that robotic manipulator 102A may also retrieve object 106 from processing module 101B and deliver it to a location on module 101A for processing, or further transfer object 106 from module 101B to a neighboring module.

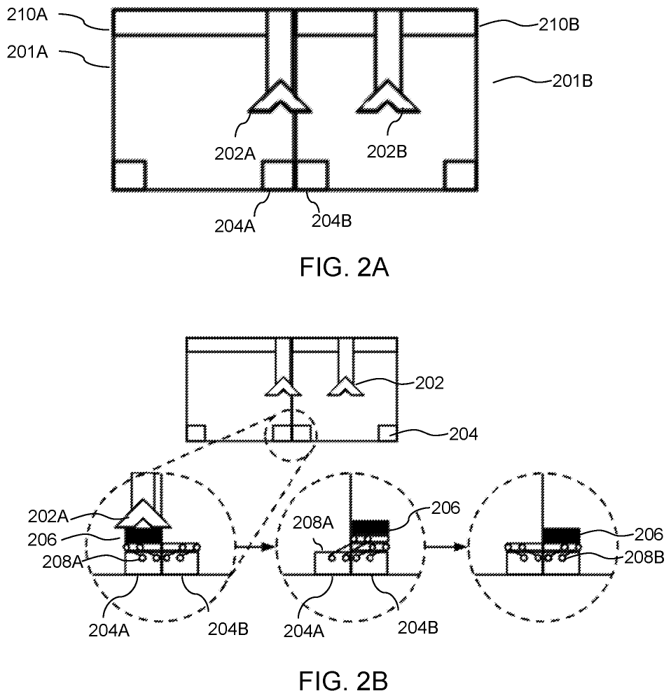

FIGS. 2A-2B depict a side view of another example modular laboratory assembly and use, according to some embodiments.

FIG. 2A illustrates two biological processing modules 201A and 202B. Biological processing module 201A includes a robotic manipulator 202A and multiple transfer decks (or slots) 204A. Similarly, biological processing module 201B includes a robotic manipulator 202B and multiple transfer decks 204B. Biological processing module 201A may be coupled to biological processing module 201B via a similar coupling mechanism as described with respect to FIG. 1D.

Each of robotic manipulators 202A and 202B may be a robotic arm with an engagement mechanism that allows the robotic arm to interact with objects on its respective processing module 201. Unlike fully articulable robotic manipulators 102 described with respect to FIGS. 1A-1C, robotic manipulators 202 may be more limited in motion such that they can only access locations on or within the same biological processing module. For example, robotic manipulator 202A may be coupled to an on-board chassis 210A, such an an overhead support structure, wherein on-board chassis 210A is integral to biological processing module 201A (e.g., an on-board gantry). This allows robotic manipulator 202A to move parallel to the base of module 201A. Robotic manipulator 202A may then be able to move in a vertical direction (i.e., towards and away from chassis 210A) via an extension and retraction system internal to robotic manipulator 202A. In this way, robotic manipulator 202A may reach any location on or within the volume of biological processing module 201A, but not outside of biological processing module 201A. As with robotic manipulator 102A, robotic manipulator 202A may include an engagement mechanism that allows the robotic arm to interact with objects within the volume of processing module 201A. Robotic manipulator 202B operates in a similar manner with regard to processing module 202B.

Referring now to FIG. 2B, because robotic manipulator 202A, for example, cannot itself reach beyond the edges of biological processing module 201A, biological processing module 201A may also include one or more independent transfer mechanisms 208A located at each transfer deck 204A. Similarly, biological processing module 201B may include one or more independent transfer mechanisms 208B located at each transfer deck 204B. An independent transfer mechanism may be, for example, a roller, slider, pusher, lifter, pulley, or the like.

When an object 206 is to be moved from processing module 201A to processing module 201B, robotic arm 202A may first move object 206 to transfer platform 204A. Platform 204A is equipped with an independent transfer mechanism 208A that operates to lift or otherwise shift object 206 to transfer platform 204B on processing module 201B. Once object 206 has been transferred to platform 204B, independent transfer mechanism 208A may return to its ready position at platform 204A. As object 206 is then located on platform 204B, robotic manipulator 202B may access object 206, and/or object 206 may be moved elsewhere by independent transfer mechanism 208B.

Each of independent transfer mechanisms 208A and 208B may be able to move object 206 along a single axis (e.g., horizontally) or multiple axes (e.g., in three dimensions) Each of independent transfer mechanisms 208A and 208B may include a platform attached to rollers or other manipulators to shift an object therefrom.

While FIGS. 1A-1C illustrate each module as having a robotic manipulator 102 capable of extending beyond the bounds of its respective module, and FIGS. 2A-2B illustrate each module as having a robotic manipulator 202 that is not capable of extending beyond the bounds of its respective module, a skilled artisan would recognize that a biological processing module having a robotic manipulator 102 may be coupled to another biological processing module having a robotic manipulator 202. Additionally or alternatively, a biological processing module having a robotic manipulator 102 may be coupled to another biological module having no robotic manipulator at all, such that robotic manipulator 102 is responsible for retrieving objects from or transferring objects to the adjacent processing module.

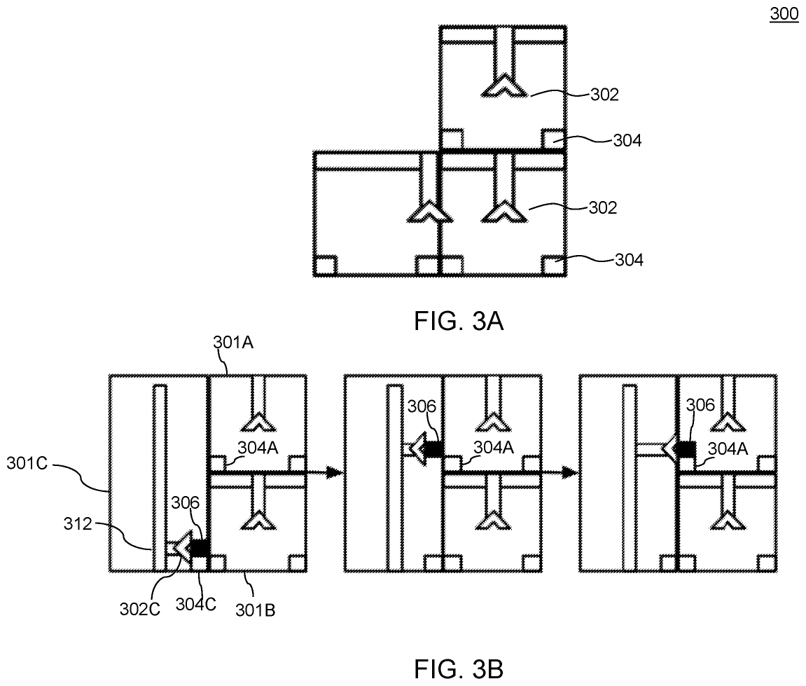

FIG. 3A illustrates a side view of a modular laboratory assembly 300 made up of three biological processing modules coupled to each other. A skilled artisan will recognize that additional biological processing modules may be added to assembly 300 in any order, such that each biological processing module is coupled to any adjacent module using respective coupling mechanisms as illustrated in FIG. 1D.

FIG. 3B depicts a side view of an example modular laboratory assembly construction where biological processing modules are arranged one above the other. Objects may be transferred from one layer to the next in an elevator like fashion. The elevators may assist in transferring lower layers to upper layers or upper layers to lower layers. For example, biological processing module 301A may be located physically (i.e., in free space) above biological processing module 301B. A third biological processing module 301C may include a robotic manipulator 302C coupled to a vertical elevator rail 312. Robotic manipulator 302C may include an engagement mechanism that allows robotic manipulator 302C to move object 306 from transfer deck 304C on module 301C to transfer deck 304A on module 301A.

According to embodiments herein, biological processing modules may also be able to detect when other modules are placed adjacent to them through, for example, a handshaking protocol. This may be effected through electromagnetic data transfer, electrical contacts, or other means enabled by the coupling mechanism, such as coupling mechanism 108 (FIG. 1D). The detection of an adjacent module allows a module to coordinate transfers to and from the detected module, such that the modules may act as a single system.

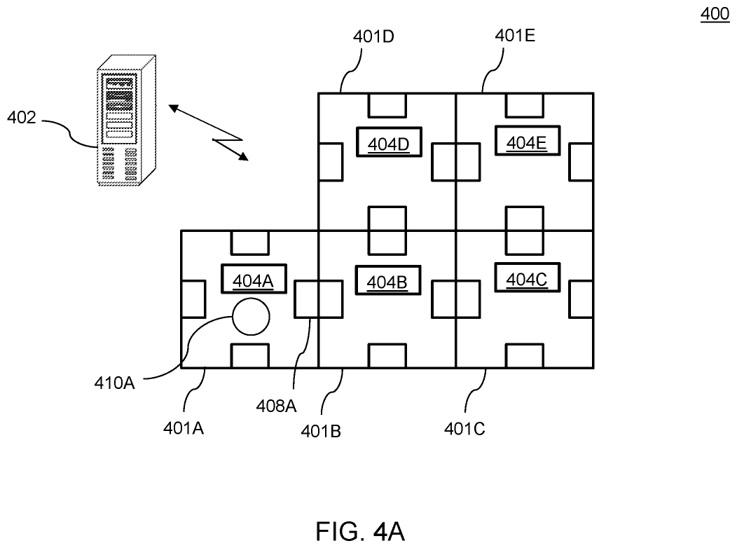

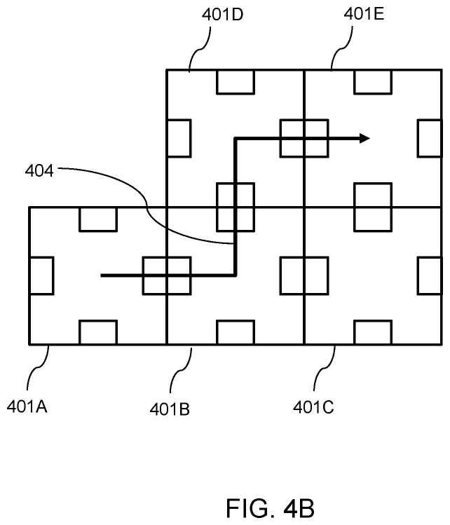

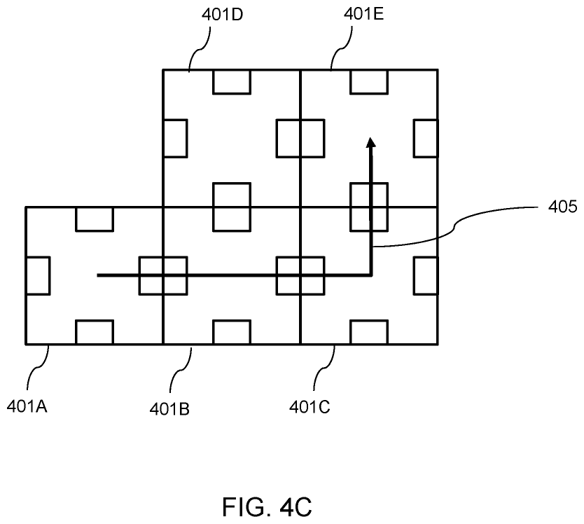

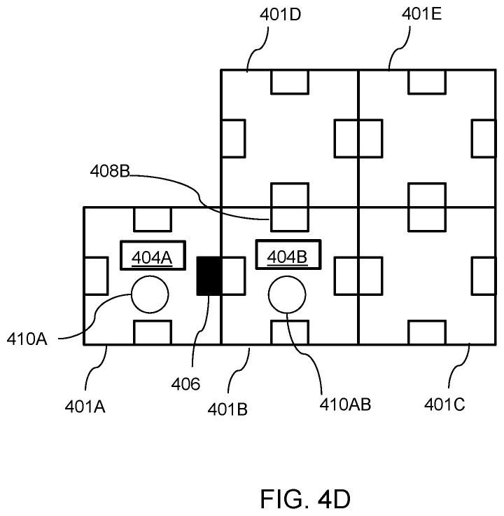

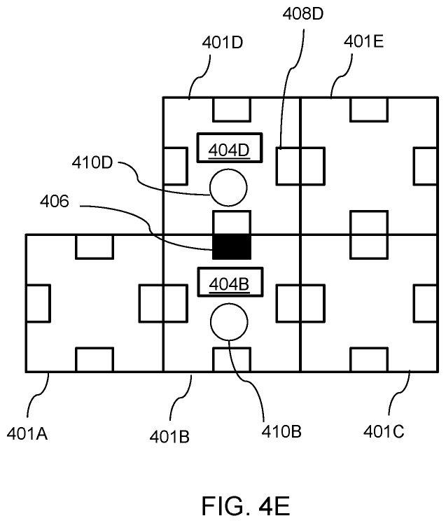

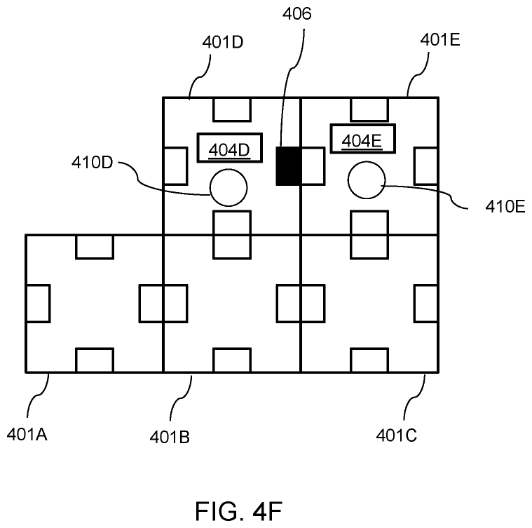

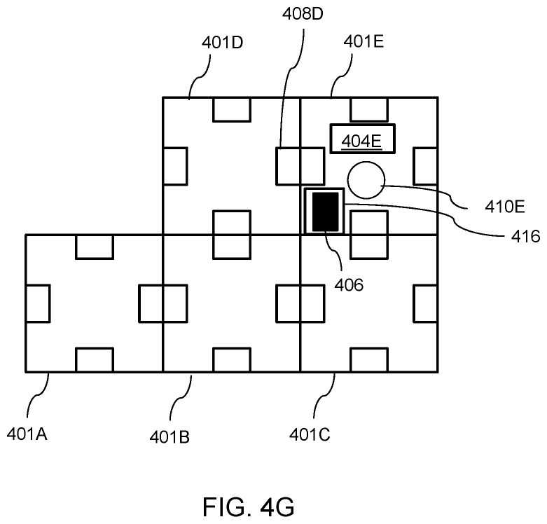

Methods of use and operation of the modular system will now be described. FIGS. 4A-4G illustrate top-down views of a modular laboratory assembly across which an object is being moved. Turning to FIG. 4A, an automated, modular laboratory assembly 400 is illustrated in a top-down view. Assembly 400 includes biological processing modules 401A-401E in communication with a central controller 402. Central controller 402 may be a laptop, desktop computer, mobile phone, tablet, or other computing device. Central controller 402 may communicate to each of modules 401A-401E through a wired or wireless connection, such as Bluetooth. In some embodiments, central controller 402 may communicate to each of modules 401A-401E through a network. The network can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks. Although central controller 402 is shown as separate from each of biological processing modules 401A-401E, central controller 402 may alternatively be integrated into a single biological processing module 401, which may then be identified as a master module. Central controller 401 is responsible for executing a particular biological process by providing operating instructions to one or more of biological processing modules 401A-401E.

Each biological processing module 401 also includes its own module controller 404. Each module controller 404 may include a communications interface for receiving data from and transmitting data to central controller 402. Module controller 404 contains information about the biological processing module, and provides operation instructions to electro-mechanical components on the biological processing module. For example, module controller 404A contains information about biological processing module 401A, and provides operations instructions to electro-mechanical components on biological processing module 401A, such as its robotic manipulator. Each module controller 404 may also be coupled to its respective module's coupling mechanism for coupling to and exchanging handshake information with adjacent modules.

Operations of central controller 402 and/or module controllers 404 may be performed by processing logic that can comprise hardware (e.g., circuitry, dedicated logic, programmable logic, microcode, etc.), software (e.g., instructions executing on a processing device), or a combination thereof. It is to be appreciated that not all steps or operations may be needed to perform the disclosure provided herein. Further, some of the steps or operations may be performed simultaneously, or in a different order than described herein, as will be understood by a person of ordinary skill in the art.

During assembly of modular lab assembly 400, each biological processing module is registered with central controller 402 as it is added to the system. For example, once biological processing module 401A is connected to power, module controller 404A may send information about module 401A to central controller 402. Module controller 404A may also send calibration details regarding the functional components located on module 401A. Such calibration details may include, for example, data which corrects for mechanical defects by adjusting the robotic manipulator using software. For example, a robotic joint may have a “home” position, which may be slightly off due to an assembly error, but which can be found using a calibration routine in software. Calibration details may additionally or alternatively include data used to make the robotic manipulator, devices, tools, etc. present within the volume of the biological processing module more accurate. Central controller 402 uses this information to register module 401A and identify its functional capabilities. Central controller 402 also begins to create a virtual map (e.g., graph) of the modular assembly by adding module 401A as a node in its virtual map.

When biological processing module 401B is coupled to module 401A via the modules' respective coupling mechanisms, module controller 404B may send information about module 401B and its relative position to module 401A to central controller 402. Module controller 404B may also send calibration details regarding the functional components located on module 401B. Additionally, module controller 404A may send additional information to central controller 402 about module 401A′s relative position to newly-added module 401B. Central controller 402 uses this information to register module 401B and identify its functional capabilities, and adds a node corresponding to module 401B to its virtual map. Because information about the relative positioning between modules 401A and 401B was also received, central controller 402 can include in its virtual graph an edge between the nods for modules 401A and 401B, the edge identifying the spatial relationship between the two modules.

Module 401B may be powered via its own electrical power connection, or it may receive power via its coupling mechanism shared with module 401A.

Modules 401C-401E may be added to the assembly and registered with central controller 402 in a similar manner. Once all modules have been added, central controller 402 completes its virtual map (e.g., graph) of the spatial relationship between all the components, along with their individual functionalities. For example, the lab assembly may have a coordinate system determined by the orientation of the assembled modules. In the example of assembly 400, module controller 404A notifies central controller 402 that module 401A is a freezer module. Module controller 404A further notifies central controller 402 that module 401A is coupled to module 401B, an incubator module, on its east side. Similarly, module controller 404B notifies central controller 402 that module 401B is an incubator module. Module controller 404B further notifies central controller 402 that module 401B is coupled to module 401A, a freezer module, on its west side. From this information, central computer 402 will determine the spatial orientations of and relationship between modules 401A and 401B. Central computer 402 may then create an edge connecting the two in its virtual map, which may be laid out in the central computer as a logical structure.

When a biological process is to be operated using one or more of modules 401A-401E, a user provides an initial protocol to central controller 402. In some embodiments, protocols for a variety of actions are stored in central controller 402, and the user may select a requested protocol from a list provided by central controller 402. For example, a PCR process may be desired to be executed, and a protocol for executing the PCR task may be provided to or retrieved by central controller 402. Other protocols may include, for example and without limitation, serial dilution, DNA assembly, DNA sequencing, DNA extraction, and protein purification.

In order to execute the desired task, central controller 402 may determine that a variety of steps may need to occur. For example, a 96-well plate may need to be retrieved from a freezer module and transferred to a pipettor module.

Central controller 402 may first determine, based on its stored virtual map, that module 401A is the freezer module, and that module 401E is the pipettor module. Central controller 402 may then consult its map to determine the best path to move objects from module 401A to module 401E. For example, central controller 402 may calculate a shortest path between module 401A and module 401E using one or more machine learning algorithms, such as an A* algorithm or Dijkstra algorithm. These algorithms attempt to find the shortest path between nodes in a weighted graph, for example. An example shortest path 404 between module 401A and module 401E is illustrated in FIG. 4B, passing from module 401A to module 401E as follows: 401A-401B-401D-401E. In some cases, there may be multiple “shortest paths” between two nodes (i.e., two paths are the same but require the same distance or number of steps). FIG. 4C illustrates another example shortest path 405 between module 401A and module 401E, passing from module 401A to module 401E as follows: 401A-401B-401C-401E. When there are multiple “shortest paths,” additional weighting or logical analyses may be performed to select the most optimal path of the shortest paths. For example, a robotic manipulator on module 401C may be busy with a different task at the time an object is desired to be transferred from module 401A to module 401E. In such a case, central controller 402 may use activity data for module 401C to determine that shortest path 404 should be selected for use.

After calculating the shortest path, the central computer may then determine discrete steps to be undertaken by each element in each module along the path in order to execute the task. Turning to FIG. 4D, in the example where module 401A is a freezer module, central computer 402 may transmit instructions to module controller 404A to move a robotic manipulator 410A located on module 401A such that robotic manipulator 410A opens a freezer component located on module 401A and extracts an object 406, such as a 96-well plate, from the freezer. Central computer 402 may transmit further instructions to module controller 404A to move robotic manipulator 410A such that the extracted 96-well plate is placed on transfer deck 408A. Central computer 402 may then transmit instructions to module controller 404B to move a robotic manipulator 410B located on module 401B such that robotic manipulator 410B retrieves object 406 from neighboring transfer deck 408A and places object 406 on its own transfer deck 408B (see FIG. 4E). Central computer 402 may then transmit instructions to module controller 404D to move a robotic manipulator 410D located on module 401D, such that robotic manipulator 410D retrieves object 406 from neighboring transfer deck 401B and places object 406 on its own transfer deck 408D (see FIG. 4F). Central computer 402 may then transmit instructions to module controller 404E to move a robotic manipulator 410E located on module 401E, such that robotic manipulator 410E retrieves object 406 from neighboring transfer deck 408D and delivers it to a pipetting station 416 located on module 401E (FIG. 4G).

FIGS. 4D-4F illustrate movement of object 406 using robotic manipulators 410 that are capable of extending outside the volume of their respective biological processing modules, such that they are able to retrieve objects from neighboring transfer platforms 408. A skilled artisan will recognize that additional steps may be taken utilizing additional transfer platforms and independent transfer mechanisms to transfer between neighboring platforms, when the robotic manipulators are unable to extend outside the volume of their respective biological processing modules.

In embodiments, central controller 402 may communicate with multiple biological processing modules 401 in parallel. For instance, following the example provided above, while robotic manipulator 410A is executing its task of transferring object 406 from a freezer to transfer deck 408A, central controller may concurrently send a separate instruction to module controller 404C of biological processing module 401C. It may be, for instance, that the pipettor of module 401C already holds a 96-well plate that needs to be transferred to an incubator, after which time the pipettor of module 401C would be available to receive object 406. In such a case, central controller 402 may instruct robotic manipulator 410C of module 401C to move an existing plate on the pipettor to a transfer deck of adjoining biological processing module 401E. Robotic manipulator 410C can execute this task at the same time robotic manipulator 410A is executing its own task, increasing efficiency of the overall system and, in turn, increasing throughput and reducing downtime.

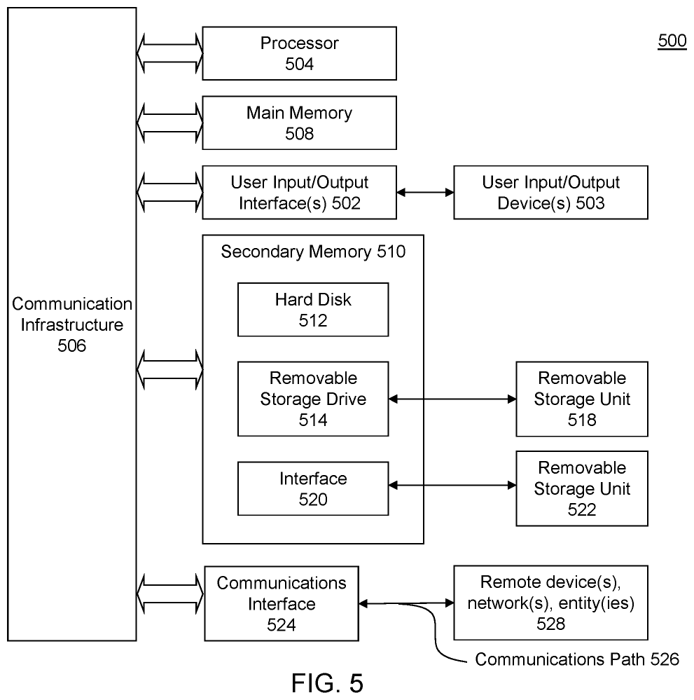

In this way, materials are moved around modular lab assembly 400 for processing. Various embodiments may be implemented, for example, using one or more well-known computer systems, such as computer system 500 shown in FIG. 5. For example, the media device 106 may be implemented using combinations or sub-combinations of computer system 500. Also or alternatively, one or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments may operate with software, hardware, and/or operating system implementations other than those described herein.

It is to be appreciated that the Detailed Description section, and not any other section, is intended to be used to interpret the claims. Other sections may set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A modular laboratory assembly, comprising:
a central controller; and
a plurality of biological processing modules, each biological processing module comprising:
a robotic manipulator;
a plurality of transfer decks within a volume of the biological processing module;
a plurality of coupling mechanisms on respective sides of the biological processing module; and
a module controller in communication with the central controller, the robotic manipulator, and the plurality of coupling mechanisms.

2. The modular laboratory assembly of claim 1, wherein each coupling mechanism comprises:
a pogo pin positioned so as to contact a pogo pin pad on an adjacent biological processing module; and
a pogo pin pad positioned so as to contact a pogo pin on the adjacent biological processing module.

3. The modular laboratory assembly of claim 1, wherein a physical layout of each coupling mechanism is the same on each biological processing module.

4. The module laboratory assembly of claim 1, wherein the plurality of biological processing module includes one or more of: a freezer, a refrigerator, a pipettor, an incubator, an optical analysis device, a heater, a centrifuge, a PCR machine, a sequencer, a room temperature storage module, a shaker, a gripper, a tube and tube cap manipulator, a spectrophotometer, or a metrology device.

5. The modular laboratory assembly of claim 1, wherein the robotic manipulator comprises an articulable robotic arm capable of accessing one or more locations outside a volume of its respective biological processing module.

6. The modular laboratory assembly of claim 1, wherein:
the robotic manipulator on a given biological processing module comprises a robotic arm whose reach is limited to a volume of the given biological processing module; and
the given biological processing module further comprises an independent transfer mechanism configured to move an object from within the volume of the given biological processing module to a location outside the volume of the given biological processing module.

7. The modular laboratory assembly of claim 6, wherein the independent transfer mechanism is collocated with one of the plurality of transfer decks on the given biological processing module.

8. A method, comprising:
receiving first identification information from a first biological processing module, the first identification information identifying a function of the first biological processing module, wherein the first biological processing module has a first robotic manipulator;
adding a first node representing the first biological processing module to a logical structure representing a virtual map;
receiving second identification information from a second biological processing module, the second identification information identifying a function of the second biological processing module, wherein the second biological processing module has a second robotic manipulator;
adding a second node representing the second biological processing module to the logical structure representing the virtual map;
receiving, from the first biological processing module, first positional information regarding a spatial relationship between the first biological processing module and the second biological processing module;
receiving, from the second biological processing module, second positional information regarding the spatial relationship between the first biological processing module and the second biological processing module;
adding an edge between the first node and the second node to the logical structure representing the virtual map, the edge representing the spatial relationship between the first biological processing module and the second biological processing module;
sending executable instructions to the first biological processing module to move the first robotic manipulator in a manner that moves an object on the first biological processing module to a first transfer location on the first biological processing module.

9. The method of claim 8, wherein sending executable instructions to the first biological processing module to move the first robotic manipulator comprises:
identifying a task requiring movement of the object from the first biological processing module to the second biological processing module; and
calculating a path from the first biological processing module to the second biological processing module.

10. The method of claim 9, wherein calculating a path from the first biological processing module to the second biological processing module comprises executing a shortest path algorithm.

11. The method of claim 10, wherein the shortest path algorithm comprises at least one of an A* algorithm or a Dijkstra algorithm.

12. The method of claim 8, further comprising:
receiving third identification information from a third biological processing module, the third identification information identifying a function of the third biological processing module, wherein the third biological processing module has a third robotic manipulator;
adding a third node representing the third biological processing module to a logical structure representing a virtual map;
receiving, from the third biological processing module, third positional information regarding a spatial relationship between the third biological processing module and at least one of the first biological processing module or the second biological processing module;
when the third positional information includes a spatial relationship between the third biological processing module and the first biological processing module, adding an edge between the third node and the first node to the logical structure representing the virtual map; and
when the third positional information includes a spatial relationship between the third biological processing module and the second biological processing module, adding an edge between the third node and the second node to the logical structure representing the virtual map.

13. A computer readable storage medium having instructions stored thereon that, when executed by a computer, cause the computer to perform operations comprising:
receiving first identification information from a first biological processing module, the first identification information identifying a function of the first biological processing module, wherein the first biological processing module has a first robotic manipulator;
adding a first node representing the first biological processing module to a logical structure representing a virtual map;
receiving second identification information from a second biological processing module, the second identification information identifying a function of the second biological processing module, wherein the second biological processing module has a second robotic manipulator;
adding a second node representing the second biological processing module to the logical structure representing the virtual map;
receiving, from the first biological processing module, first positional information regarding a spatial relationship between the first biological processing module and the second biological processing module;
receiving, from the second biological processing module, second positional information regarding the spatial relationship between the first biological processing module and the second biological processing module;
adding an edge between the first node and the second node to the logical structure representing the virtual map, the edge representing the spatial relationship between the first biological processing module and the second biological processing module;
sending executable instructions to the first biological processing module to move the first robotic manipulator in a manner that moves an object on the first biological processing module to a first transfer location on the first biological processing module.

14. The computer readable storage medium of claim 13, wherein sending executable instructions to the first biological processing module to move the first robotic manipulator comprises:
identifying a task requiring movement of the object from the first biological processing module to the second biological processing module; and
calculating a path from the first biological processing module to the second biological processing module.

15. The computer readable storage medium of claim 14, wherein calculating a path from the first biological processing module to the second biological processing module comprises executing a shortest path algorithm.

16. The computer readable storage medium of claim 15, wherein the shortest path algorithm comprises at least one of an A* algorithm or a Dijkstra algorithm.

17. The computer readable storage medium of claim 13, the operations further comprising:
receiving third identification information from a third biological processing module, the third identification information identifying a function of the third biological processing module, wherein the third biological processing module has a third robotic manipulator;
adding a third node representing the third biological processing module to a logical structure representing a virtual map;
receiving, from the third biological processing module, third positional information regarding a spatial relationship between the third biological processing module and at least one of the first biological processing module or the second biological processing module;
when the third positional information includes a spatial relationship between the third biological processing module and the first biological processing module, adding an edge between the third node and the first node to the logical structure representing the virtual map; and
when the third positional information includes a spatial relationship between the third biological processing module and the second biological processing module, adding an edge between the third node and the second node to the logical structure representing the virtual map.
